(19) United States
(12) Patent Application Publication
(10) Pub. No.: US 2019/0372266 A1
(43) Pub. Date: Dec. 5, 2019

(54) Metal Housing Connector

(71) Applicant: Huawei Technologies Co., Ltd., Shenzhen, Guangdong (CN)

(72) Inventor: Hiromitsu Kodama, Yokohama (JP)

(21) Appl. No.: 16/485,080

(22) PCT Filed: Feb. 9, 2017
(86) PCT No.: PCT/CN2017/073171

§ 371 Date: Aug. 9, 2019

(51) Int. Cl. H01R 13/52; H01R 13/405; H01R 13/50; C25D 11/14; C25D 11/26

(52) U.S. Cl. CPC H01R 13/521; H01R 13/405; G04B 37/22; C25D 11/14; C25D 11/26; H01R 13/50

(57) ABSTRACT

The present invention relates to an electrical connector assembly comprising a housing made of metal and two or more electrical contact members assembled in the housing, wherein anodic oxidation coating films are applied on the housing so as to enable electrical insulation between the adjacent electrical contact members.

### BACKGROUND OF THE INVENTION

### Field of the Invention

The present invention relates to an electrical connector assembly, and more particularly, an electrical connector assembly comprising a housing made of metal.

### Description of the Related Art

An electrical connector assembly is one of the key components mounted in an electronic device. General connector assemblies comprise a housing and a plurality of electrical contact members assembled in the housing. In order to prevent a short circuit between the contact members, an electric insulation property is required for the housing. Conventional electrical connector assemblies usually comprise a housing made of engineering plastics which have electric insulation as well as excellent mechanical and/or thermal properties. When coloring is required for the housing, a colorant such as a pigment may be added to an engineering plastic material for molding the housing.

Aesthetic appearance and/or high grade feeling of the housing made of engineering plastics is lacking for use of an external connector which is visible to end users. In particular, when the housing made of engineering plastics is disposed adjacent to a metallic exterior of a final product equipped with the connector assembly, uniformity of the appearance of the design of the product may be impaired. Also, a colored housing made of engineering plastics is not brilliant and lacks aesthetics of appearance and/or high grade feeling. It is desirable to make a housing of an external connector exhibit a more excellent appearance. In addition, coloring of engineering plastics is limited in variation such as black, white, beige, blue, green, etc. It is desirable to have many variations of coloring of a housing.

Plating for metal materials is generally known as a means for producing texture and/or high grade feeling. However, no electrical insulating housing is available by plating since a plating film has electrical conductivity. In addition, coloring by plating is limited in variation of color.

There exists a need to address the aforementioned unresolved problems of conventional electrical connector assemblies, in particular, to improve aesthetics of the appearance of a housing of the connector assembly and to increase variation of coloring of the housing, while ensuring electrical insulation of the housing.

### SUMMARY OF THE INVENTION

An object of the present invention is to provide an electrical connector assembly wherein a housing can exhibit a brilliant, metallic and beautiful appearance so that the appearance of the design of the final product equipped with the connector assembly is not impaired even if the housing of the electrical connector assembly is exposed to the exterior of the product.

This object is achieved by means of one aspect of the invention which is an electrical connector assembly comprising a housing made of metal and two or more electrical contact members assembled in the housing, wherein anodic oxidation coating films are applied on the housing so as to enable electrical insulation between the adjacent electrical contact members.

By means of this electrical connector assembly, the anodic oxidation coating films applied on the metallic housing are capable of exhibiting a brilliant, metallic and beautiful appearance as well as electrical insulation. Therefore, excellent aesthetics of the appearance appearance and/or high grade feeling of the housing can be achieved while the housing can prevent a short circuit between the contact members. In addition, since the anodic oxidation coating films may develop various colors according to several factors such as the kind of metal contained in a processing object, kind of electrolyte solution, dipping time of the object in the electrolyte solution, etc., color appearance of the housing can be selected from among a variety of kinds of colors. Therefore, in one embodiment of the electrical connector assembly, the anodic oxidation coating films may be adapted to develop a desired color. Furthermore, the electrical connector assembly according to the invention may be adapted to be mounted in an electronic device so that a portion of the housing is exposed to the exterior of the device.

In one embodiment of the electrical connector assembly, the electrical connector assembly may further comprise one or more fixing elements for fixing the contact members to the housing. In this embodiment, the contact members may be loosely housed in the housing and the fixing elements may be interposed between the exterior of each contact member and the interior of the housing. The fixing elements may include a glue applied in a cavity of the housing, and the glue may be a waterproof glue. The fixing elements may include a gasket for each contact member. The gasket may be press-fitted into a hole defined in the housing, and the contact member may be press-fitted into the gasket. The fixing elements may include a molded body which is formed integrally with the housing by insert molding. This molded body may define fixing holes into which the contact members are respectively press-fitted. Alternatively, the fixing elements may include a molded body which is formed integrally with the contact members by insert molding. This molded body may be press-fitted into the housing.

In a preferred embodiment of the electrical connector assembly, a terminal surface of each contact member, which is exposed from the front end of the housing, may be recessed with respect to the front end of the housing.

According to another aspect of the invention, there is provided a housing for an electrical connector, wherein the housing is made of metal and configured to house two or more electrical contact members, and wherein anodic oxidation coating films are applied on the housing so as to enable electrical insulation between the adjacent electrical contact members.

According to a further aspect of the invention, there is provided an electronic device including an electrical connector assembly according to the above-mentioned aspect, wherein at least one side of the housing of the connector assembly as well as a terminal of each contact member are arranged in the exterior of the device. In this embodiment, the connector assembly may be for power supply to the device.

In a preferred embodiment of the electrical connector assembly, the connector assembly is adapted to be mounted in a wearable device such as a wrist watch type device (also called a smart watch). Nevertheless, the electrical connector assembly according to the invention may be mounted in other kinds of electronic devices, such as smartphones, mobile phones, tablet-type computers, notebook-type computers, desk calculators, electronic notebooks, portable televisions, digital cameras, medical apparatuses, or the like.

### BRIEF DESCRIPTION OF THE DRAWINGS

The invention can be better understood from the following detailed description of non-limiting embodiments thereof, and on examining the accompanying drawings, in which:

FIG. 1 shows a front view schematic diagram of an electrical connector assembly according to a first embodiment of the invention;

FIG. 2 shows a side view schematic diagram of the electrical connector assembly according to the first embodiment of the invention;

FIG. 3 shows a cross-sectional schematic diagram of the electrical connector assembly according to the first embodiment of the invention;

FIG. 4 shows a cross-sectional schematic diagram of the electrical connector assembly according to a second embodiment of the invention;

FIG. 5 shows a cross-sectional schematic diagram of the electrical connector assembly according to a third embodiment of the invention;

FIG. 6 shows a perspective diagram of an electronic device according to one embodiment of the invention;

FIG. 7 shows a front view schematic diagram of an electrical connector assembly according to one variation of the embodiments of the invention;

FIG. 8 shows a front view schematic diagram of an electrical connector assembly according to another variation of the embodiments of the invention; and

FIG. 9 shows a front view schematic diagram of an electrical connector assembly according to yet another variation of the embodiments of the invention.

FIG. 10 shows a front view schematic diagram of an electrical connector assembly according to another variation of the embodiments of the invention.

### DETAILED DESCRIPTION OF THE PREFERRED EMBODIMENTS

### Electrical Connector Assembly and Housing

### First Embodiment

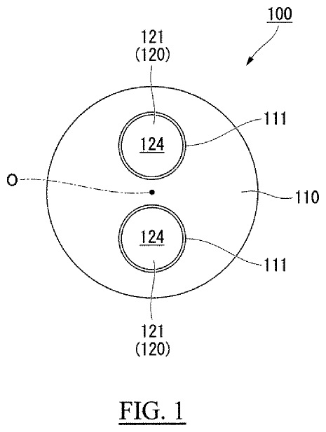

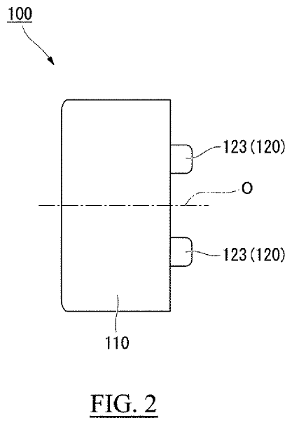

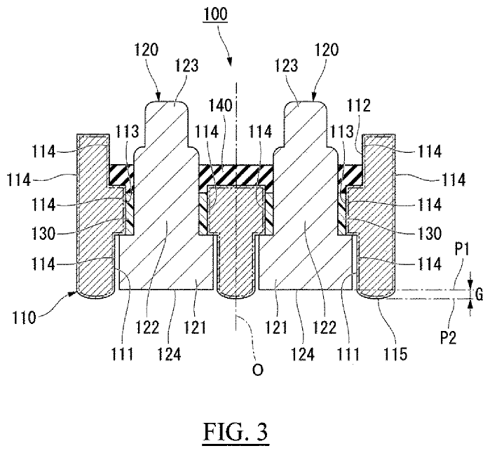

The electrical connector assembly 100 shown in FIGS. 1 to 3 is suitable for an external connector for power supply to an electronic device (not shown in these figures), and is adapted to be mounted in the electronic device so that a front side of the electrical connector assembly 100 is exposed to the exterior of the device. FIG. 1 illustrates the exposed front side of the connector assembly 100. In the illustration of FIG. 2, the exposed front side of the connector assembly 100 is on the left side of the drawing, and the back side of the connector assembly 100 is on the right side of the drawing, which may be embedded into a main body of the device. Similarly, in the illustration of FIG. 3, the exposed front side of the connector assembly 100 is on the upper side of the drawing, and the back side of the connector assembly 100 is on the lower side of the drawing.

As shown in FIGS. 1 to 3, the electrical connector assembly 1 comprises a housing 110 and two electrical contact members 120 and 120.

The housing 110 is made of metal which can be subjected to an anodic oxidation coating process. The metal used for the housing 110 may include pure metals or metal alloys such as pure aluminum, aluminum alloys, stainless steel, pure titanium, titanium alloys, etc. The housing 110 is generally formed into a columnar shape which has a central axis O extending from the back side to the front side.

The front section of the housing 110 is provided with two recessed cavities 111 and 111 which are opened on the front side. The front cavities 111 and 111 are adapted to accommodate loosely terminal portions 121 and 121 of the contact members 120 and 120, respectively, and both are formed into a cylindrical shape. The two front cavities 111 and 111 are arranged symmetrically with respect to the central axis O. The back section of the housing 110 is provided with a recessed cavity 112 which is opened on the back side. The housing 110 further includes two through holes 113 and 113 each of which communicates the front cavity 111 with the back cavity 112. Each hole 113 extends in a direction along the central axis O and is adapted to accommodate loosely an intermediate portion 122 of the contact member 120.

Anodic oxidation coating films 114 having an electrical insulation property are applied on the housing 110 so as to enable electrical insulation between the adjacent electrical contact members 120 and 120. The housing 110 is subjected to an anodic oxidation coating process over the entire surface thereof, and the anodic oxidation coating films 114 are formed on the whole surface of the housing 110. The anodic oxidation coating process may be performed through conventional steps for anodic oxidation processing by using conventional anodic oxidation processing equipment. Specifically, a conventional alumite treatment method may be performed to form the anodic oxidation coating films 114 on the housing 110. The kind of metal contained in the material of the housing 110, the kind of an electrolyte solution in the anodic oxidation coating process, and/or dipping time in the anodic oxidation coating process are adapted so that the anodic oxidation coating films 114 develop a desired color.

The electrical contact members 120 and 120 are made of electrically conductive materials. The electrical contact members 120 and 120 are assembled in the housing 110 and are loosely housed in the housing 110. Each electrical contact member 120 comprises the terminal portion 121, the intermediate portion 122, and a connection portion 123. The terminal portion 121 is located on the front section of the contact member 120, the connection portion 123 is located on the back section of the contact member 120, and the intermediate portion 122 is located between the terminal portion 121 and the connection portion 123.

The terminal portion 121 has a generally columnar shape and includes a terminal surface 124 which is exposed from a front side of the housing 110 so as to be able to be in contact with a mating contact of a counterpart connector (not shown in the figures). The terminal surface 124 is a flat surface and is recessed with respect to the front end 115 of the housing 110 so that a gap G exists between a plane P1 of the terminal surface 124 of the contact member 120 and a plane P2 of the front end 115 of the housing 110. The diameter of the terminal portion 121 is less than the diameter of the front cavity 111 of the housing 110 so that the terminal portion 121 is loosely fitted into the front cavity 111 of the housing 110. This can prevent the anodic oxidation coating films 114 on the interior of the front cavity 111 from being scraped off with the terminal portion 121 of the contact member 120.

The intermediate portion 122 extends backward from the terminal portion 121 and connects the terminal portion 121 with the connection portion 123. The diameter of the intermediate portion 122 is less than the diameter of the hole 113 of the housing 110 so that the intermediate portion 122 can be loosely inserted into the hole 113 and the back cavity 112 of the housing 110. This can prevent the anodic oxidation coating films 114 on the interior of the hole 113 and the back cavity 112 from being scraped off with the intermediate portion 122 of the contact member 120.

The connection portion 123 extends backward from the intermediate portion 122. The connection portion 123 is configured to be convenient for fastening by soldering, etc. to a circuit board mounted within the main body of the electrical device (not shown in the figures). Specifically, the connection portion 123 is formed thinner and protrudes to the outside of the housing 110.

The connector assembly 100 further comprises two kinds of fixing elements 130 and 140 for fixing the contact members 120 and 120 to the housing 110. The fixing elements 130 and 140 are interposed between the exterior of each contact member 120 and the interior of the housing 110. The fixing elements include a gasket 130 for each contact member 120 and glue 140 applied in the back cavity 112 of the housing 110.

The gasket 130 is shaped into a cylindrical ring and is press-fitted into the hole 113 of the housing 110. The gasket 130 is a sealing and fixing member which is capable of sealing between the intermediate portion 122 of the contact member 120 and the hole 113 of the housing 110 as well as holding the intermediate portion 122 of the contact member 120 while being held within the hole 113 of the housing 110. The length of the gasket 130 is less than or equal to the length of the hole 113, and the gasket 130 is fully contained in the hole 113. The gasket 130 has a softness that prevents the anodic oxidation coating films 114 from being scraped off with the gasket 130. The gasket 130 preferably has electric insulation. For example, the gasket 130 is made of silicon polymer.

The glue 140 is applied over a bottom area of the back cavity 112 so that the glue 140 seals between the intermediate portion 122 of each contact member 120 and the interior of the housing 110 and so that both the contact members 120 and 120 are fixed to the housing 110 with the glue 140 so as not to move. The glue 140 is a waterproof glue such as ultraviolet curing type, double fluid type, thermal curing type, etc.

An exemplary method of manufacturing the electrical connector assembly 100 according to the first embodiment comprises the following steps:
providing the housing 110 made of metal by molding, etc.;
performing an anodic oxidation coating process on the housing 110 to form the anodic oxidation coating films 114 on the housing 110;
press-fitting the gasket 130 into the hole 113 of the housing 110;
attaching the contact members 120 and 120 to the housing 110, wherein the intermediate portion 122 of each contact member 120 is press-inserted into the gasket 130 and the terminal portion 121 of each contact member 120 is loosely fitted in the front cavity 111 of the housing 110; and
applying the glue 140 in the back cavity 112 of the housing 110.

According to the electrical connector assembly 100 described above, the anodic oxidation coating films 114 applied on the housing 110 are capable of exhibiting a brilliant, metallic and beautiful appearance as well as electrical insulation properties. Therefore, excellent aesthetics of appearance and/or high grade feeling of the housing 110 can be achieved while the housing 110 can prevent a short circuit between the contact members 120 and 120. In particular, since the contact members 120 and 120 are loosely housed in the housing 110 to prevent the anodic oxidation coating films 114 from being scraped off with the contact members 120 and 120, the electrical connector assembly 100 can ensure the electric insulation of the housing 110. Moreover, the anodic oxidation coating films 114 can develop various colors according to several factors. Therefore, the color appearance of the housing 110 can be selected from among a variety of kinds of colors.

In addition, according to the electrical connector assembly 100 described above, the gasket 130 and the glue 140 can serve to improve waterproofing performance of the connector assembly 100 as well as fix the contact members 120 and 120 to the housing 110. Furthermore, the gap G between the plane P1 of the terminal surface 124 of the contact member 120 and the plane P2 of the front end 115 of the housing 110 can prevent from short-circuiting between the terminal surfaces 124 and 124 of the contact members 120 and 120 to avoid galvanic corrosion. For example, even if any electrolyte such as sweat of a user is attached on the front side of the electrical connector assembly 100, the gap G can be useful for preventing the terminal surfaces 124 and 124 of the contact members 120 and 120 from connecting to each other through the electrolyte.

### Second Embodiment

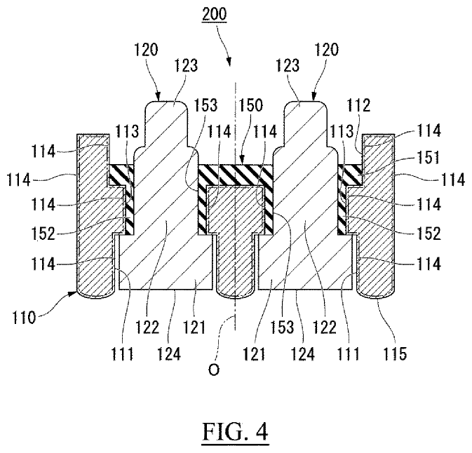

FIG. 4 shows an electrical connector assembly 200 according to the second embodiment of the invention. The electrical connector assembly 200 has common characteristics with the electrical connector assembly 100 of the above-described first embodiment, and a detailed description of these common characteristics is omitted. The following is a detailed description of different characteristics of the electrical connector assembly 200 as compared to the electrical connector assembly 100 of the first embodiment.

As shown in FIG. 4, the connector assembly 200 comprises one kind of fixing element 150 for fixing the contact members 120 and 120 to the housing 110. The fixing element 150 is interposed between the exterior of each contact member 120 and the interior of the housing 110. The fixing element includes a molded body 150 made of resin which is formed integrally with the housing 110 by insert molding. The molded body 150 comprises a first portion 151 which is arranged within the back cavity 112 of the housing 110 and two second portions 152 and 152 each of which is filled in the hole 113 of the housing 110. The molded body 150 defines through holes 153 and 153 each of which extends from the back side of the first portion 151 to the front side of the second portion 152 in a direction along the central axis O. The holes 153 and 153 of the molded body 150 are for fixing the contact members 120 and 120 to the housing 110. The intermediate portions 122 and 122 of the contact members 120 and 120 are respectively press-fitted into the holes 153 of the molded body 150.

An exemplary method of manufacturing the electrical connector assembly 200 according to the second embodiment comprises the following steps:
providing the housing 110 made of metal by molding, etc.;
performing an anodic oxidation coating process on the housing 110 to form the anodic oxidation coating films 114 on the housing 110;
forming the molded body 150 integrally with the housing 110 by insert molding; and
press-inserting each contact member 120 into the hole 153 of the molded body 15 from the front side of the housing 110.

According to the electrical connector assembly 200 described above, the molded body 150 can serve to improve waterproofing performance of the connector assembly 200 as well as fix the contact members 120 and 120 to the housing 110.

### Third Embodiment

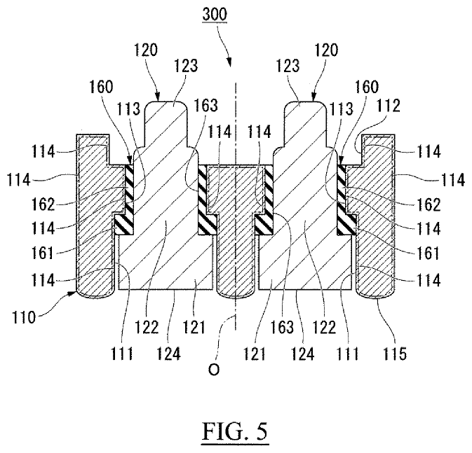

FIG. 5 shows an electrical connector assembly 300 according to the third embodiment of the present application. The electrical connector assembly 300 has common characteristics with the electrical connector assemblies 100 and 200 of the above-described first and second embodiments, and a detailed description of these common characteristics is omitted. The following is a detailed description of different characteristics of the electrical connector assembly 300 as compared to the electrical connector assemblies 100 and 200 of the first and second embodiments.

As shown in FIG. 5, the connector assembly 300 comprises two fixing elements 160 and 160 for fixing the contact members 120 and 120 to the housing 110. Each fixing element 160 is interposed between the exterior of each contact member 120 and the interior of the housing 110. Each fixing element includes a molded body 160 made of resin which is formed integrally with the contact member 120 by insert molding. The molded body 160 comprises a first portion 161 which is arranged within the front cavity 111 of the housing 110 and a second portion 162 which is filled in the hole 113 of the housing 110. The molded body 160 defines through hole 163 which extends from the front side of the first portion 161 to the back side of the second portion 162 in a direction along the central axis O. The intermediate portion 122 of the contact member 120 is press-fitted into the hole 163 of the molded body 160.

An exemplary method of manufacturing the electrical connector assembly 300 according to the second embodiment comprises the following steps:
providing the housing 110 made of metal by molding, etc.;
performing an anodic oxidation coating process on the housing 110 to form the anodic oxidation coating films 114 on the housing 110;
for each contact member 120, forming the molded body 160 integrally with the contact member 120 by insert molding; and
press-inserting each molded body 160, which has been formed around the intermediate portion 122 of the contact member 120, into the front cavity 111 and the hole 113 of the housing 110 from the front side of the housing 110.

According to the electrical connector assembly 300 described above, the molded bodies 160 and 160 can serve to improve waterproofing performance of the connector assembly 300 as well as fix the contact members 120 and 120 to the housing 110.

### Electronic Device

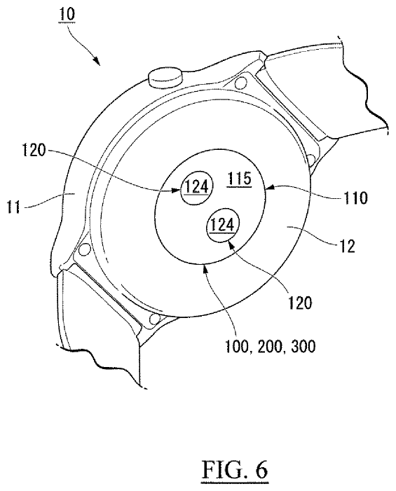

FIG. 6 shows an exemplary electronic device 10 including the electrical connector assembly 100, 200, 300 described above. The electronic device 10 is a wrist watch type device, that is, a smart watch, which comprises a main body 11, a back lid 12 attached to the back side of the main body 11, and the electrical connector assembly 100, 200, 300 which is mounted in the main body 11. The end surface 115 of the housing 110 of the connector assembly 100, 200, 300 as well as the terminal surface 124 of each contact member 120 are arranged in the exterior of the device 10, that is, in the back lid 12 to be exposed and visible to a user. According to the device 10, due to the brilliant, metallic and beautiful appearance of the housing 110, the appearance of the design of the device 10 is not impaired.

### Variations

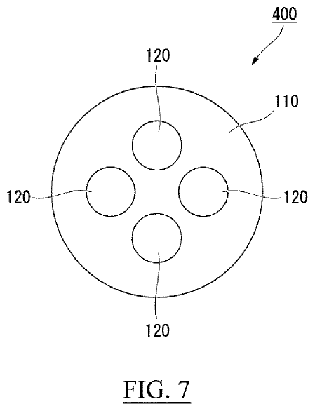

The above-stated embodiments describe the connector assemblies 100, 200, 300 having two electrical contact members 120 and 120, but the number of contact members can be appropriately changed. The connector assembly according to the invention may include three or more electrical contact members, for example, as shown in FIG. 7, the connector assembly 400 may have four electrical contact members 120, 120, 120, and 120.

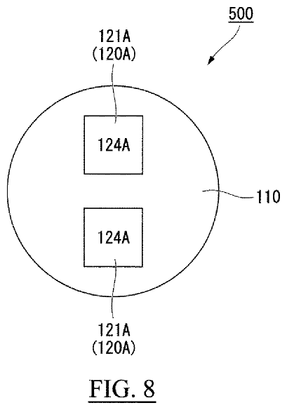

The above-stated embodiments describe that the terminal portion 121 of each contact member 120 has a generally columnar shape and includes a circular terminal surface 124, but the shape of the contact members can be appropriately changed. For example, the terminal portion 121A of each contact member 120A of the connector assembly 500 may have a prismatic shape and may include a rectangular terminal surface 124A, as shown in FIG. 8.

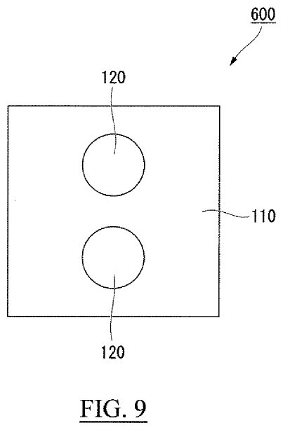

The above-stated embodiments describe that the housing 110 is generally formed into a columnar shape, but the shape of the housing can be appropriately changed. For example, the housing 110A of a connector assembly 600 may be formed into a prismatic shape, as shown in FIG. 9.

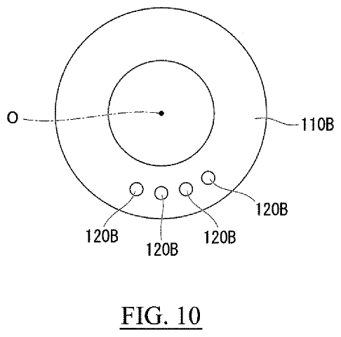

The above-stated embodiments describe that the front cavities 111 in the housing 110 and the contact members 120 respectively positioned in the cavities are arranged symmetrically with respect to the central axis O, but the arrangement of the cavities and the arrangement of the contact members can be appropriately changed and may be asymmetrical with respect to the central axis of the housing. For example, all of a plurality of contact members 120B may be arranged on the same side with respect to the central axis O of the housing 110B, as shown in FIG. 10.

Furthermore, the above-described variations may be combined with each other or any one of the above-stated embodiments. Although preferred embodiments of the present invention have been disclosed for illustrative purposes, those skilled in the art will appreciate that various modifications, additions, and substitutions are possible, without departing from the scope and spirit of the invention as disclosed in the accompanying claims.

1. An electrical connector assembly comprising:
a housing comprising metal;
adjacent electrical contact members assembled in the housing; and
anodic oxidation coating films disposed on the housing and configured to provide electrical insulation between the adjacent electrical contact members.

2. The electrical connector assembly of claim 1, wherein the anodic oxidation coating films are adapted to develop a desired color.

3. The electrical connector assembly of claim 1, further comprising one or more fixing elements configured to fix the adjacent electrical contact members to the housing, wherein the adjacent electrical contact members are loosely housed in the housing, and wherein the fixing elements are interposed between an exterior of each adjacent electrical contact member and an interior of the housing.

4. The electrical connector assembly of claim 3, wherein the fixing elements comprise a glue applied in a cavity of the housing.

5. The electrical connector assembly of claim 4, wherein the glue comprises a waterproof glue.

6. The electrical connector assembly of claim 3, wherein the fixing elements comprise a gasket for each adjacent electrical contact member, wherein each gasket is press-fitted into a hole defined in the housing, and the adjacent electrical contact members are press-fitted into the gaskets.

7. The electrical connector assembly of claim 3, wherein the fixing elements comprise a molded body which is formed integrally with the housing by insert molding, and wherein the molded body defines fixing holes into which the adjacent electrical contact members are press-fitted.

8. The electrical connector assembly of claim 3, wherein the fixing elements include a molded body which is formed integrally with the adjacent electrical contact members by insert molding, and wherein the molded body is press-fitted into the housing.

9. The electrical connector assembly of claim 3, wherein a terminal surface of each adjacent electrical contact member is exposed from a front end of the housing and is recessed with respect to the front end.

10. (canceled)

11. An electronic device comprising:
a first exterior; and
an electrical connector assembly comprising:
a housing disposed on the first exterior and comprising metal,
adjacent electrical contact members assembled in the housing and comprising terminals disposed on the first exterior, and
anodic oxidation coating films disposed on the housing and configured to provide electrical insulation between the adjacent electrical contact members.

12. The electronic device of claim 11, wherein the electrical connector assembly is configured to supply power to the electronic device.

13. The electronic device of claim 11, wherein the anodic oxidation coating films are adapted to develop a desired color.

14. The electronic device of claim 11, further comprising one or more fixing elements configured to fix the adjacent electrical contact members to the housing, wherein the adjacent electrical contact members are loosely housed in the housing, and wherein the fixing elements are interposed between an exterior of each adjacent electrical contact member and an interior of the housing.

15. The electronic device of claim 14, wherein the fixing elements comprise a glue applied in a cavity of the housing.

16. The electronic device of claim 15, wherein the glue comprises a waterproof glue.

17. The electronic device of claim 14, wherein the fixing elements comprise a gasket for each adjacent electrical contact member, wherein each gasket is press-fitted into a hole defined in the housing, and the adjacent electrical contact members are press-fitted into the gaskets.

18. The electronic device of claim 14, wherein the fixing elements comprise a molded body which is formed integrally with the housing by insert molding, and wherein the molded body defines fixing holes into which the adjacent electrical contact members are press-fitted.

19. The electronic device of claim 14, wherein the fixing elements include a molded body which is formed integrally with the adjacent electrical contact members by insert molding, and wherein the molded body is press-fitted into the housing.

20. The electronic device of claim 14, wherein a terminal surface of each adjacent electrical contact member is exposed from a front end of the housing and is recessed with respect to the front end.

21. The electrical connector assembly of claim 1, wherein the electrical connector assembly is configured to supply power to an electronic device.
